(19) United States
(12) Patent Application Publication
(10) Pub. No.: US 2002/0096846 A1
(43) Pub. Date: Jul. 25, 2002

(54) Cushion and steering device for scooter

(76) Inventor: Ming-Fu Chen, Changhua (TW)

Correspondence Address: BACON & THOMAS, 625 Slaters Lane - 4th Floor, Alexandria, VA, 22314, US

(21) Appl. No.: 09/765,643

(22) Filed: Jan. 22, 2001

(51) Int. Cl. B62M 1/00

(52) U.S. Cl. 280/87.041

(57) ABSTRACT

A scooter includes a bar transversely connected to the front end of the board and two L-shaped arms are pivotally connected to two ends of the bar. Two front wheels are respectively connected to the two arms. A shaft member has two rear wheels respectively connected to two ends of the shaft member and a U-shaped frame is connected to a top of the shaft member. A mediate member fixedly connected on an underside of the board is pivotally connected between two extensions of the U-shaped frame. When steering, the board is inclined and the rear wheels will not be lifted above the ground.

### FIELD OF THE INVENTION

The present invention relates to a cushion and steering device for both front wheels and rear wheels of a scooter.

### BACKGROUND OF THE INVENTION

A conventional scooter is shown in FIG. 6 and generally includes a board 60 with a front fork 61 connected to a front end of the board 60 and two rear wheels 80 connected side by side on a rear end of the board 60. A handlebar stem 62 extends from the front fork 61 and two arms 72 respectively pivotally connected to two extensions of the front fork 61. Two front wheels 71 are connected to the two arms 72 and a spring 73 is biased between a rod 74 extending from respective one of the two arms 72 and a block 63 on the front fork 61. When steering the handlebar and inclining the board 60, one of the springs 73 is compressed and the other is extended. Nevertheless, one of the rear wheels 80 could fly above the ground and makes the scooter in an unstable status.

The present invention intends to provide a cushion and steering device for scooter wherein two springs are connected between the shaft of the two rear wheels and the board so as to provide a stable steering feature on the rear wheels.

### SUMMARY OF THE INVENTION

In accordance with one aspect of the present invention, there is provided a scooter and comprises a board and a handlebar stem extends from a front end of the board. A bar is transversely connected to the front end of the board and two L-shaped arms are pivotally connected to two ends of the bar. Two front wheels are respectively connected to the two arms. A shaft member has two rear wheels respectively connected to two ends of the shaft member and a U-shaped frame is connected to a top of the shaft member and a mediate member is pivotally connected between two extensions of the U-shaped frame. The mediate member is fixedly connected to an underside of a rear end of the board.

The primary object of the present invention is to provide a cushion and steering device for the scooter that allows the board be inclined while the rear wheels won't leave from the ground.

These and further objects, features and advantages of the present invention will become more obvious from the following description when taken in connection with the accompanying drawings which show, for purposes of illustration only, several embodiments in accordance with the present invention.

### BRIEF DESCRIPTION OF THE DRAWINGS

FIG. 1 is a perspective view to show a scooter of the present invention;

FIG. 2 is an exploded view to show a cushion and steering device of the scooter of the present invention;

FIG. 3A is a top view to show the connection between front wheels and the board;

FIG. 3B is a top view to show when the front wheels of the scooter turn;

FIG. 4A is an end view to show the connection between rear wheels and the board;

FIG. 4B is an end view to show when the board is inclined when the scooter turns;

FIG. 5 is a top view to show another embodiment of the connection between the front wheels and the board, and

FIG. 6 is a perspective view to show a conventional scooter.

### DETAILED DESCRIPTION OF THE PREFERRED EMBODIMENTS

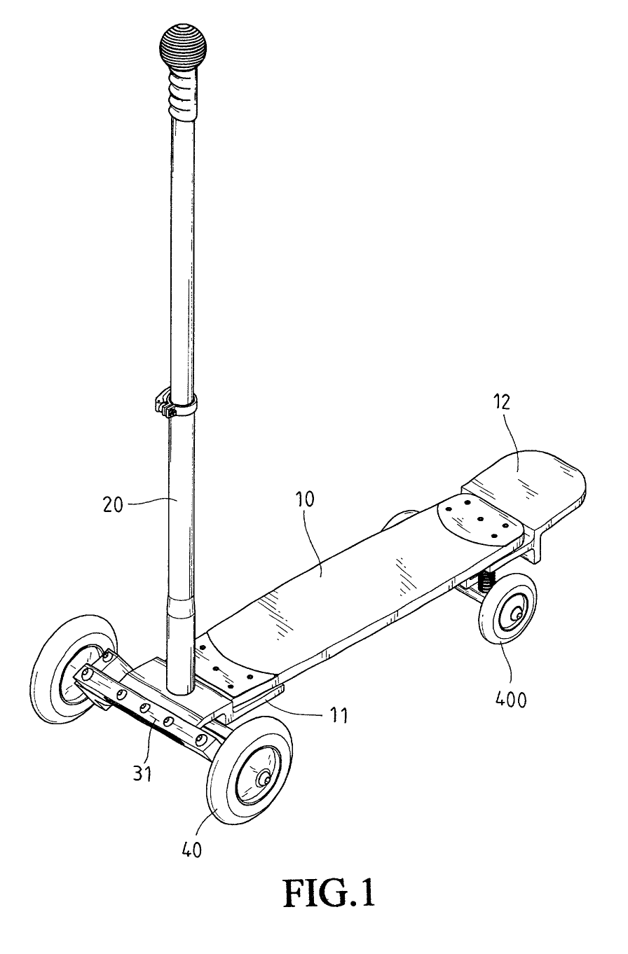

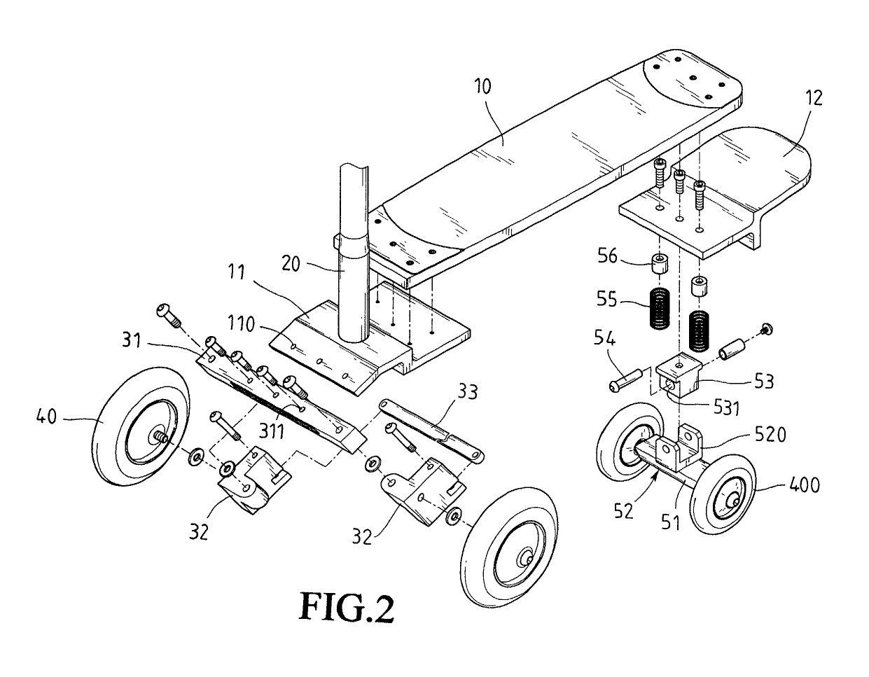

Referring to FIGS. 1, 2, 3A and 4A, the scooter of present invention comprises a board 10 and a front connection plate 11 is connected to a front end of the board 10. A handlebar stem 20 extends from the front connection plate 11. A bar 31 has a plurality of first holes 311 defined therethrough and the front connection plate 11 has second holes 110 so that bolts extend through the first holes 311 in the bar 31 and are engaged with the second holes 110 of the front connection plate 11. The bar 31 is therefore transversely connected to the front end of the board 10 and two L-shaped arms 32 are pivotally connected to two ends of the bar 31 at two respective first ends of the two arms 32. Two front wheels 40 are respectively connected to the two arms 32 and a link 33 is pivotally connected between two respective second ends of the two arms 32.

A rear connection plate 12 is fixedly connected to a rear end of the board 10 and mediate member 53 is fixedly connected to an underside of the rear connection plate 12. A shaft member 51 has two rear wheels 400 respectively connected to two ends of the shaft member 51 and a U-shaped frame 52 is connected to a top of the shaft member 51. The mediate member 53 is pivotally connected between two extensions 520 of the U-shaped frame 52 by extending a pin 54 through holes in the two extensions 520 and a hole 531 in the mediate member 53. Two sleeves 56 are fixedly connected an underside of the rear connection plate 12 and two springs 55 are connected between the two sleeves 56 and the shaft member 51. The U-shaped frame 52 is located between the two springs 55.

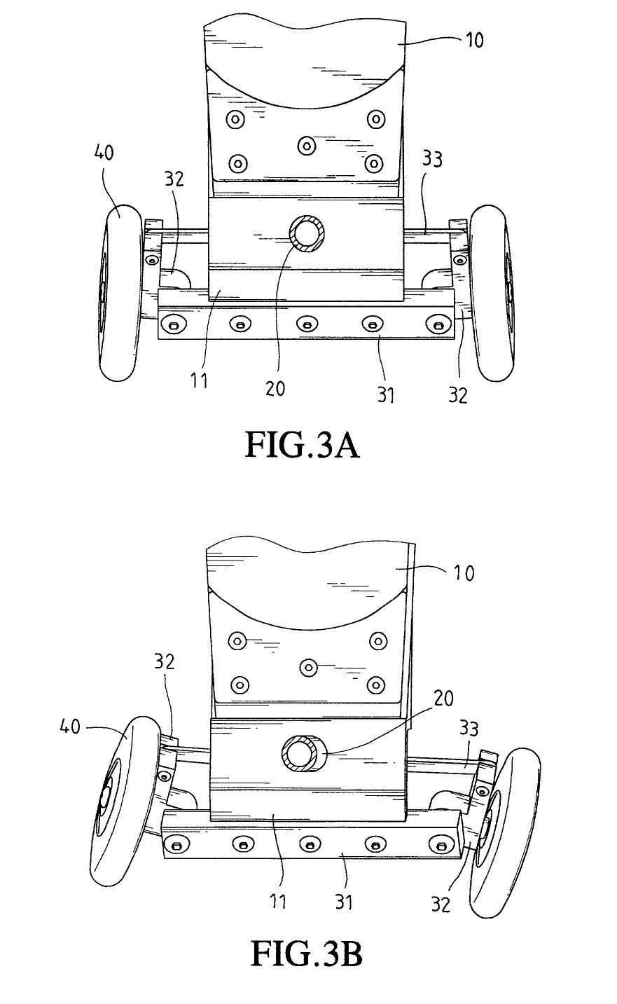

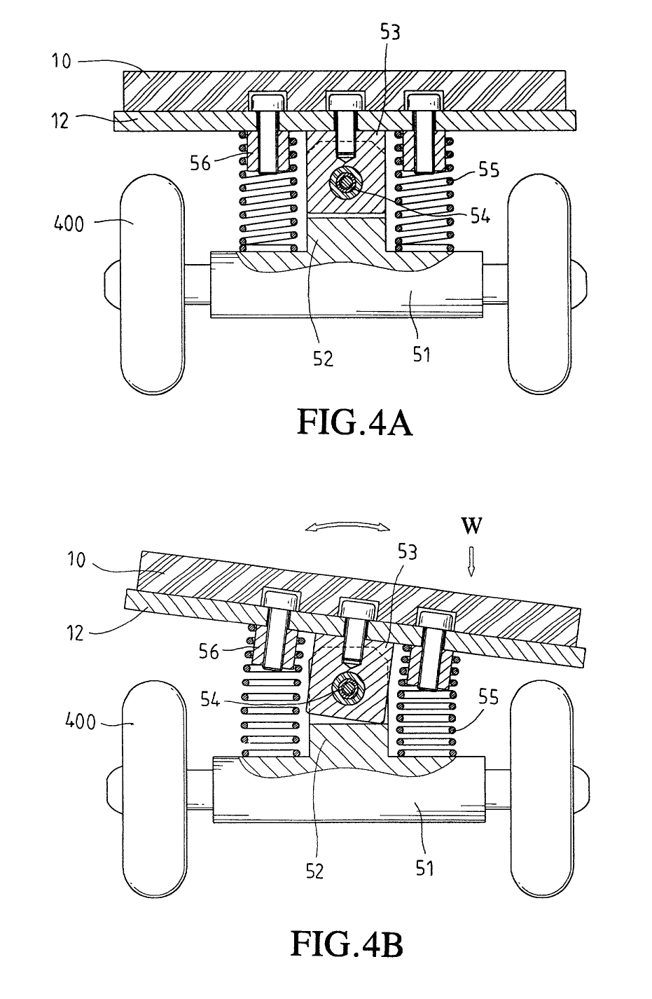

Referring to FIGS. 3B and 4B, when steering, the board 10 can be inclined due to the load “W” of the player and one spring is compressed and the other is extended. The mediate member 53 is also pivoted within the two extensions 520. In other words, only the board 10 is inclined and neither of the two rear wheels 400 leaves the ground. This makes the scooter more stable when turning or performing stunt actions.

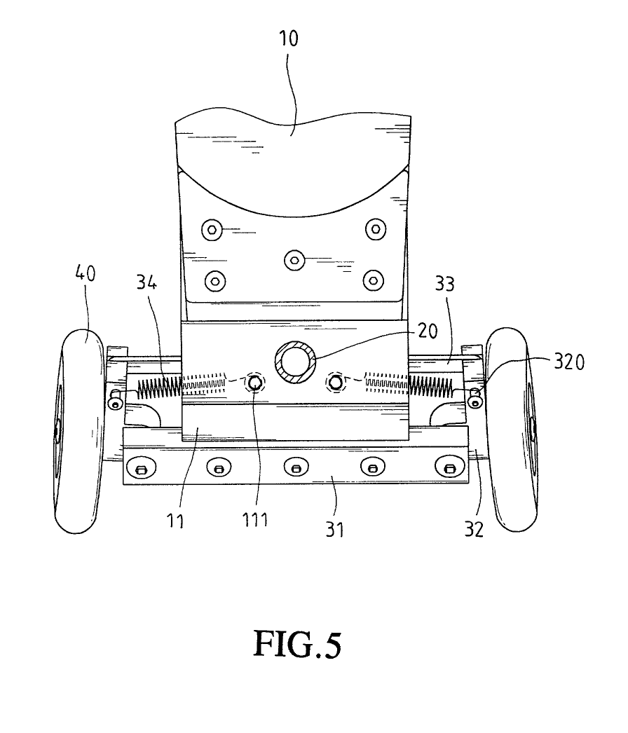

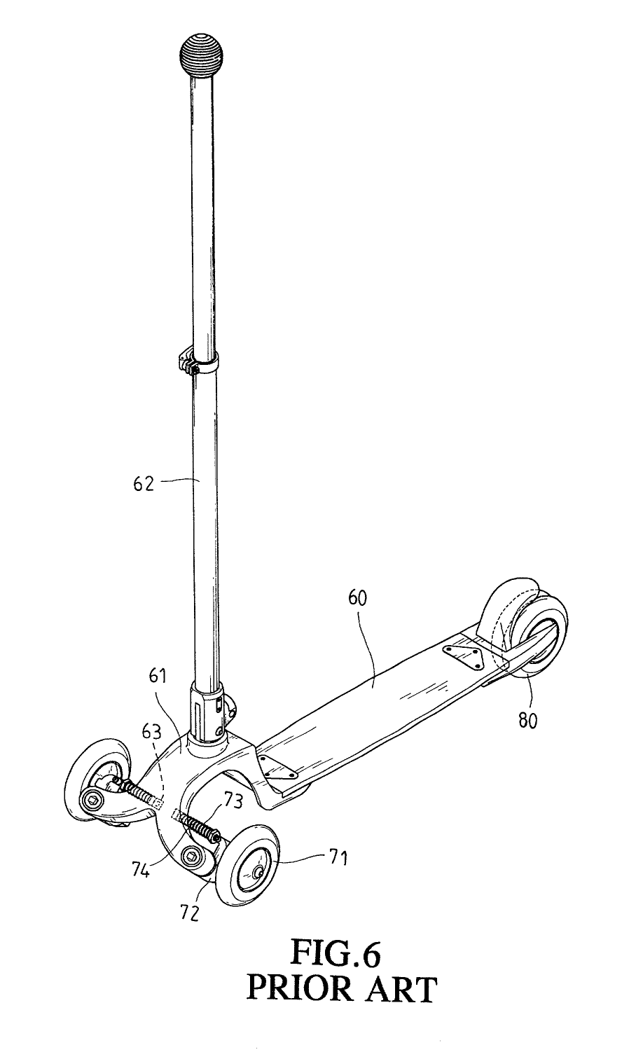

FIG. 5 shows another embodiment of the scooter wherein two first pins 111 extend from an under side of the front connection plate 11 and each of the arms 32 has a second pin 320 extending therefrom. A spring 34 is connected between each of the first pins 111 and each of the second pins 320. The springs 34 return the front wheels 40 after turning.

While we have shown and described various embodiments in accordance with the present invention, it should be clear to those skilled in the art that further embodiments may be made without departing from the scope and spirit of the present invention.

What is claimed is:

1. A scooter comprising:
a board and a handlebar stem extending from a front end of said board, a bar transversely connected to said front end of said board and two L-shaped arms pivotally connected to two ends of said bar at two respective first ends of said two arms, two front wheels respectively connected to said two arms, and
a shaft member having two rear wheels respectively connected to two ends of said shaft member, a U-shaped frame connected to a top of said shaft member and a mediate member pivotally connected between two extensions of said U-shaped frame, said mediate member fixedly connected to an underside of a rear end of said board.

2. The scooter as claimed in claim I further comprising a link pivotally connected between two respective second ends of said two arms.

3. The scooter as claimed in claim 1 farther comprising two springs connected between said rear end of said board and said shaft member, said U-shaped frame located between said two springs.

4. The scooter as claimed in claim 1 wherein said bar has a plurality of first holes defined therethrough and said front end of said board has second holes so that bolts extend through said first holes and engaged with said second holes.

5. The scooter as claimed in claim 1 wherein two first pins extend from an under side of said front end of said board and each of said arms has a second pin extending therefrom, a spring connected between each of said first pins and each of said second pins.
